(19) United States
(12) Patent Application Publication
(10) Pub. No.: US 2001/0050479 A1
(43) Pub. Date: Dec. 13, 2001

(54) One-piece stamped socket for hydraulic hose fittings

(76) Inventors: Howard Ice JR., Holland, OH (US); Rodney DeLong, Sylvania, OH (US); James Hudson III, Toledo, OH (US)

Correspondence Address: MARSHALL & MELHORN, LLC, Attention: Donald A. Schurr, Four Seagate - 8th Floor, Toledo, OH, 43604, US

(21) Appl. No.: 09/821,270

(22) Filed: Mar. 29, 2001

Related U.S. Application Data
(60) Provisional application No. 60/192,858, filed on Mar. 29, 2000.

(51) Int. Cl. F16L 33/00

(52) U.S. Cl. 285/256

(57) ABSTRACT

A metal socket for attachment to a flexible pressure hose comprises a cylindrical metal sleeve defining an axis, with a plurality of non-annular grooves formed in an outer surface thereof and corresponding non-annular projections formed opposite said grooves on an inner surface thereof. The socket is both economical to produce and exhibits improved strength in gripping the end of a hydraulic hose.

### BACKGROUND OF THE INVENTION

This invention relates in general to a coupling which is adapted to be crimped to an end of a flexible pressure hose and, in particular, to a unique metal socket which forms part of the coupling and is adapted to be crimped over the end of a pressure hose.

Pressure hose couplings are used in many places to connect flexible pressure hoses to moveable machinery parts. Such hoses transmit hydraulic fluids or compressed air under high pressure between such components as pumps, valves, and hydraulic actuators. The flexibility of the hose permits relative movement between such devices.

One example of a prior art hose coupling includes a collar or socket coaxially positioned around one end of a nipple and crimped to an intermediate portion of the nipple. The collar and nipple together form an annular space in which the end of a flexible hose is received. The outer surface of the nipple is typically provided with annular teeth to engage the inner surface of the hose end, while the inner surface of the collar is provided with a series of axially spaced apart annular grooves, which, when crimped, grip the outer surface of the hose end. The grooves have typically been formed in the inner surface of the collar by a machining operation.

More recently, it has been proposed in U.S. Pat. No. 5,199,751, to form such a cylindrical metal socket having a plurality of internal annular beads and a plurality of corresponding outer annular grooves formed by a single stamping operation. In particular, a forming apparatus is utilized which includes a collapsible segmented out die assembly having a plurality of inwardly projecting annular ribs, and a coaxially positioned expandable segmented inner die assembly provided with cooperating annular grooves. A cylindrical metal sleeve is then placed in coaxial relationship between the outer socket and the inner mandrel, and the inner die assembly is expanded, while the outer die assembly is collapsed, to simultaneously form all the beads in a single stamping operation. Since the die assemblies are segmented, the annular surfaces include a plurality a circumferentially spaced interruptions.

While the method described in U.S. Pat. No. 5,199,751 may provide improved economies over the noted prior methods, it would desirable to provide a socket for hydraulic hose fittings which is both economical to produce and which more strongly grips the end of the hydraulic hose.

### SUMMARY OF THE INVENTION

In accordance with the invention, a metal socket is provided for subsequent attachment to a flexible pressure hose. The socket comprises a cylindrical metal sleeve defining an axis, with a plurality of non-annular grooves formed in an outer surface thereof and corresponding non-annular projections formed opposite said grooves on an inner surface thereof.

The metal socket of the invention is formed by providing a cylindrical metal sleeve defining an axis, an outer surface and an inner surface. A plurality of non-annular grooves are formed in the outer surface of said sleeve simultaneously with the formation of corresponding non-annular projections opposite the grooves on the inner surface of said sleeve.

The invention provides a socket for hydraulic hose fittings which is both economical to produce and which exhibits improved strength in gripping the end of a hydraulic hose.

### BRIEF DESCRIPTION OF THE DRAWINGS

The advantages of the invention will become readily apparent to those skilled in the art from the following detailed description of a preferred embodiment when considered in the light of the accompanying drawings, in which:

FIG. 1 is an end view of a one-piece stamped socket for a hydraulic hose fitting in accordance with the invention;

FIG. 2 is a sectional view taken along the line 2-2 of FIG. 1, and is identical to the sectional view taken along the same line in the opposite direction;

FIG. 3 is an end view of an alternate embodiment of the socket; and

FIG. 4 is a sectional view taken along the line 4-4 of FIG. 2, and is identical to the sectional view taken along the same line in the opposite direction.

### DESCRIPTION OF THE PREFERRED EMBODIMENTS

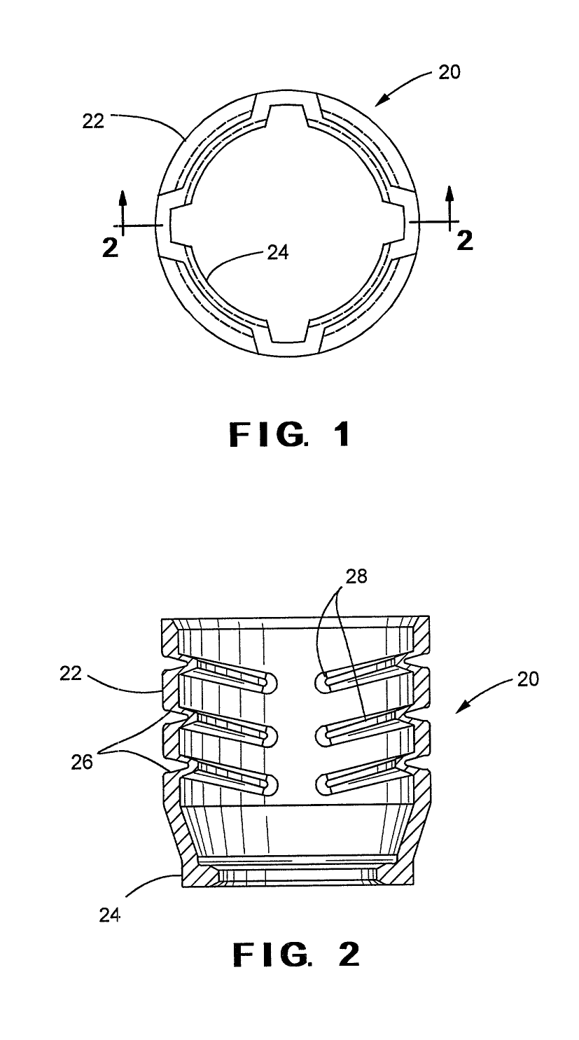

Referring now to FIGS. 1 and 2, there is shown a socket 20 in accordance with the invention for use in a pressure hose coupling which is secured to the end of a flexible pressure hose. Apart from the socket 20 of the invention, the pressure hose coupling and flexible pressure hose secured thereto are conventional, and may be the same as that shown in U.S. Pat. No. 5,199,751, which is incorporated herein by reference in its entirety.

The socket 20 includes a cylindrical sleeve 22 having a reduced diameter end 24 which, prior to attachment to the pressure hose, may be crimped to the nipple of the pressure hose coupling in the conventional manner. The outer surface of such nipple cooperates with the cylindrical sleeve 22 of the socket 20 to form an annular space for receiving the hose end.

The socket 20 further includes a plurality of axially spaced apart, non-annular grooves 26 in the outer surface thereof, and a corresponding number of non-annular projections 28 in the inner surface directly opposite the grooves. Preferably, the plurality of grooves 26 and corresponding projections 28 are formed as a plurality of axially V-shaped grooves and projections, as shown in FIG. 2. The plurality of V-shaped grooves and projections are believed to provide a significantly more secure engagement with the outer surface of a flexible pressure hose.

As also shown in FIGS. 1 and 2, the grooves 26 and projections 28 are not continuous, but include a plurality of interruptions which are a result of the specific stamping operation used to form the socket 20.

To produce the socket 20 of the invention, an initial blank is preferably formed by feeding strip steel into a miniaturized deep-draw die, so that the resulting socket is formed in a single piece, with no seams along the length of the socket. Then, a forming apparatus is used to simultaneously form the associated grooves and projections by a single stamping operation. A suitable forming apparatus includes an expandable, segmented inner die assembly and an associated axially shiftable tapered actuating mandrel, along with a collapsible, segmented outer die assembly and an associated axially shiftable tapered actuating barrel.

The outer die assembly includes a plurality of individual segments, each of which is provided with a plurality of internal projections which, when the barrel is axially shifted in a conventional manner, is adapted to form a portion of the grooves 26 in the outer surface of the socket 20. Collectively, all the outer segments cooperate to form the all of the grooves 26 in the socket 20. Similarly, an inner die assembly includes a plurality of external grooves which, when the tapered mandrel is axially shifted, are adapted to form a portion of the projections 28 in the inner surface of the socket 20.

It will be appreciated that, since both the outer and inner die assemblies are segmented, the resulting grooves and projections formed thereby will not be continuous, but will have interruptions, such as those shown in FIGS. 1 and 2, which are formed at the junction of the individual segments.

The mandrel and barrel can be axially shifted to expand the inner die and collapse the outer die assembly, thereby forming the associated grooves and projections in the socket in a single stamping operation.

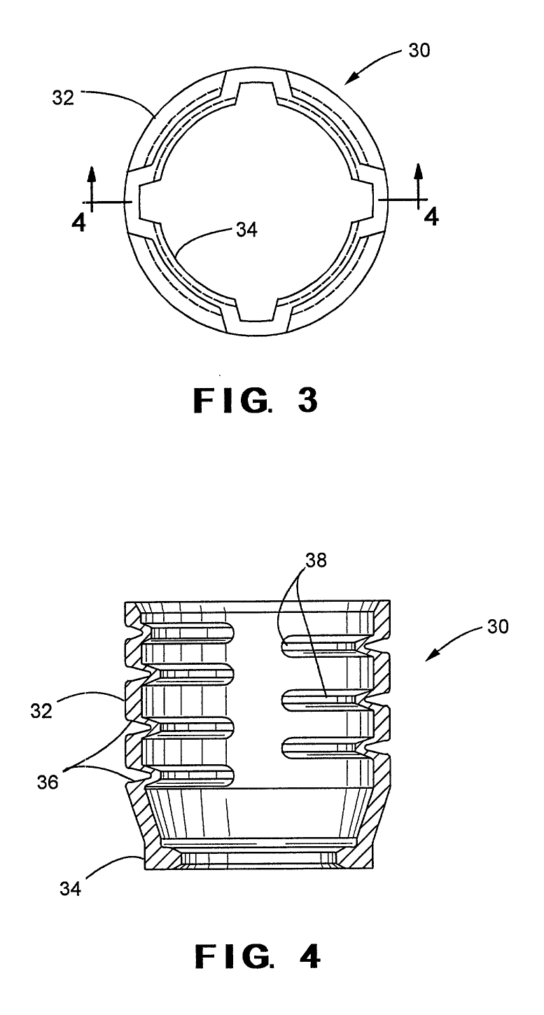

An alternate embodiment of the socket of the invention is illustrated in FIGS. 3 and 4. In FIGS. 3 and 4, there is shown a socket 30 for use in a pressure hose coupling which is secured to the end of a flexible pressure hose. The socket 30 includes a cylindrical sleeve 32 having a reduced diameter end 34 which, prior to attachment to the pressure hose, may be crimped to the nipple of the pressure hose coupling in the conventional manner. The outer surface of such nipple cooperates with the cylindrical sleeve 32 of the socket 30 to form an annular space for receiving the hose end.

The socket 30 further includes a plurality of axially spaced apart, non-annular grooves 36 in the outer surface thereof, and a corresponding number of non-annular projections 38 in the inner surface directly opposite the grooves. In this embodiment, as best seen in FIG. 4, a first plurality of grooves 36 and corresponding projections 38 extend only partially about the circumference of the sleeve 32 in planes substantially perpendicular to the axis of the sleeve 32.

In addition, a second plurality of grooves 40 and corresponding projections 42 are formed in the sleeve 32 opposite the first plurality of grooves 36 and projections 38. The second plurality of grooves 40 and projections 42 also extend only partially about the circumference of the sleeve 32 in planes substantially perpendicular to the axis of the sleeve 32. The second grooves 40 and projections 42 are formed in planes which are axially offset from the planes in which the adjacent first grooves 36 and projections 38 are formed. The socket 30 can be formed in the manner described above for the socket 20.

The socket of the invention, along with the method of producing the socket have been illustrated and described in their preferred embodiments. However, it will be appreciated the modifications to these embodiments can be made without departing form the scope of the attached claims.

What is claimed is:

1. A method of producing a cylindrical metal socket for subsequent attachment to a flexible pressure hose, comprising:
(a) providing a cylindrical metal sleeve defining an axis, an outer surface and an inner surface; and
(b) simultaneously forming a plurality of non-annular grooves in the outer surface of said sleeve and corresponding non-annular projections opposite the grooves on the inner surface of said sleeve.

2. The method as defined in claim 1, wherein said grooves and projections are formed in a single stamping operation.

3. The method as defined in claim 1, wherein a plurality of V-shaped grooves are formed in the outer surface of said sleeve simultaneously with the forming of corresponding V-shaped projections opposite the grooves on the inner surface of said sleeve.

4. The method as defined in claim 1, wherein said non-annular grooves and projections comprise a first plurality of grooves and projections and a generally opposing second plurality of grooves and projections, each of said grooves and projections extending only partially about the circumference of said sleeve in a plane substantially perpendicular to the axis of said sleeve, with the first plurality of grooves and projections being formed in planes which are axially offset from the planes in which the adjacent second plurality of grooves and projections are formed.

5. A metal socket for subsequent attachment to a flexible pressure hose comprising:
a cylindrical metal sleeve defining an axis; and
a plurality of non-annular grooves formed in an outer surface thereof and corresponding non-annular projections formed opposite said grooves on an inner surface thereof.

6. A metal socket as defined in claim 5, wherein said socket is formed in a single, seamless piece.

7. A metal socket as defined in claim 5, wherein said non-annular grooves are comprised of V-shaped grooves and said non-annular projections are comprised of V-shaped projections.

8. A metal socket as defined in claim 5, wherein said non-annular grooves and projections comprise a first plurality of grooves and projections and a generally opposing second plurality of grooves and projections, each of said grooves and projections extending only partially about the circumference of said sleeve in a plane substantially perpendicular to the axis of said sleeve, with the first plurality of grooves and projections being formed in planes which are axially offset from the planes in which the adjacent second plurality of grooves and projections are formed.
